(19) United States
(12) Patent Application Publication
(10) Pub. No.: US 2026/0030456 A1
(43) Pub. Date: Jan. 29, 2026

(54) METHOD AND APPARATUS FOR CONTROLLING SMART HOME DEVICE, ELECTRONIC DEVICE, MEDIUM, AND PRODUCT

(71) Applicant: Samsung Electronics Co., Ltd., Suwon-si (KR)

(72) Inventors: Kun WANG, Nanjing (CN); Mengyuan WU, Nanjing (CN); Jun XIE, Nanjing (CN); Yue MA, Nanjing (CN)

(73) Assignee: Samsung Electronics Co., Ltd., Suwon-si (KR)

(21) Appl. No.: 19/224,163

(22) Filed: May 30, 2025

Related U.S. Application Data
(63) Continuation of application No. PCT/KR2025/005896, filed on Apr. 30, 2025.

(30) Foreign Application Priority Data
Jul. 24, 2024 (CN) 202411004029.7

(51) Int. Cl. G06F 40/40; G06F 40/279

(52) U.S. Cl. CPC G06F 40/40; G06F 40/279

(57) ABSTRACT

Embodiments of the present disclosure disclose a method and apparatus for controlling a smart home device, an electronic device, a medium, and a product. The method includes determining a smart home device that is associated with an environmental factor to be controlled; generating a query associated with the smart home device based on a current state of the environmental factor to be controlled; inputting the query into a large language model; obtaining a reply generated based on the query from the large language model; converting the reply from the large language model into a control instruction for the smart home device; and controlling the smart home device based on the control instruction.

### CROSS-REFERENCE TO RELATED APPLICATION(S)

This application is a bypass continuation of International Application No. PCT/KR 2025/005896, filed on Apr. 30, 2025, which is based on and claims priority to China Patent Application No. 202411004029.7, filed on Jul. 24, 2024, in the China Intellectual Property Office, the disclosures of which are incorporated by reference herein in their entireties.

### TECHNICAL FIELD

The present disclosure relates to the technical field of smart home, and more particularly, to a method and apparatus for controlling a smart home device, an electronic device, a medium, and a product.

### BACKGROUND

Smart home is implemented in a platform within a residence. Home living facilities are integrated by using technologies such as comprehensive wiring, network communication, safety prevention, automatic control, and audio and video, to construct an efficient management system for residence facilities and schedule family activities. This improves the safety, convenience, comfort, and aesthetic of a home, and achieves an environment-friendly and energy-saving living environment.

With the rise of smart home products, controlling a smart home device conveniently and optimally is a technical problem continuously grappled with in the field of smart home.

### SUMMARY

Provided are a method and apparatus for controlling a smart home device, an electronic device, a medium, and a product, so as to control the smart home device conveniently and optimize a control effect.

According to an aspect of the disclosure, a method for controlling a smart home device includes determining a smart home device that is associated with an environmental factor to be controlled; generating a query associated with the smart home device based on a current state of the environmental factor to be controlled; inputting the query into a large language model; obtaining a reply generated based on the query from the large language model; converting the reply from the large language model into a control instruction for the smart home device; and controlling the smart home device based on the control instruction.

According to an aspect of the disclosure, a non-transitory computer-readable medium storing one or more instructions that are executed by one or more processors, individually or collectively, to perform a method for controlling a smart home device is provided. the method includes determining a smart home device that is associated with an environmental factor to be controlled; generating a query text associated with the smart home device based on a current state of the environmental factor to be controlled; inputting the query text into a large language model; receiving obtaining a reply text generated based on the query text from the large language model; converting the reply text from the large language model into a control instruction of for the smart home device; and controlling the smart home device based on the control instruction.

According to an aspect of the disclosure, an apparatus for controlling a smart home device includes memory storing instructions, and one or more processors. The instructions, when executed by the one or more processors individually or collectively, cause the apparatus to determine a smart home device that is associated with an environmental factor to be controlled; generate a query associated with the smart home device based on a current state of the environmental factor to be controlled; input the query into a large language model; obtain a reply generated based on the query text from the large language model; convert the reply from the large language model into a control instruction for the smart home device; and control the smart home device based on the control instruction.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A is a schematic diagram of controlling a smart home device in related art;

FIG. 1B is a schematic diagram of controlling a smart home device in related art;

FIG. 2 is an example flowchart of a method for controlling a smart home device according to an embodiment of the present disclosure;

FIG. 3A is an example diagram of description information of a smart home device according to an embodiment of the present disclosure;

FIG. 3B is an example diagram of vectors for controlling a smart home device according to an embodiment of the present disclosure;

FIG. 3C is an example diagram of vectors for controlling a smart home device according to an embodiment of the present disclosure;

FIG. 4 is a block diagram of a process for controlling a smart home device according to an embodiment of the present disclosure;

FIG. 5 is an example diagram of a process for controlling a smart home device according to an embodiment of the present disclosure;

FIG. 6 is an example block diagram of an apparatus for controlling a smart home device according to an embodiment of the present disclosure;

FIG. 7A is an example diagram of controlling a smart home device according to an embodiment of the present disclosure;

FIG. 7B is an example diagram of controlling a smart home device according to an embodiment of the present disclosure;

FIG. 7C is an example diagram of determining a smart home device associated with an environmental factor to be controlled according to an embodiment of the present disclosure; and

FIG. 8 is an example block diagram of an electronic device according to the present disclosure.

### DETAILED DESCRIPTION

Embodiments of the present disclosure will be described in detail below with reference to the accompanying drawings.

For conciseness and clarity of description, the solutions of the present disclosure are set forth below by describing a number of representative embodiments. Numerous details in the embodiments are set forth only to provide an understanding of the solutions of the present disclosure. However, it will be apparent that the technical solutions of the present disclosure may be implemented without being limited to these details. To avoid unnecessarily obscuring the solutions of the present disclosure, some embodiments have not been described in detail, but rather have been provided with a framework. Hereinafter, “including” means “including but not limited to”, and “according to” means “at least according to, but not limited to only according to”. Because of Chinese language conventions, when the number of one component is not specified below, it means that there may be one or more components, or it may be understood that there is at least one component.

In a smart home system, various smart home devices (such as audio and video devices, lighting systems, curtain control devices, air-conditioning control devices, security systems, digital cinema systems, video and audio servers, and network appliances) in the home are connected with each other through an Internet of Things (IoT) technology. Various control functions such as home appliance control, lighting control, telephone remote control, indoor and outdoor remote control, anti-theft alarm, environment monitoring, heating and ventilation control, infrared forwarding, and programmable timing control. Compared with ordinary home, smart home not only has a traditional residential function, but also incorporates building, network communication, information appliances, equipment automation, providing comprehensive information interaction functions.

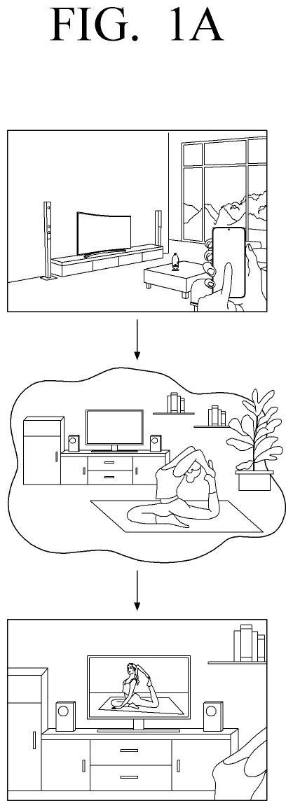

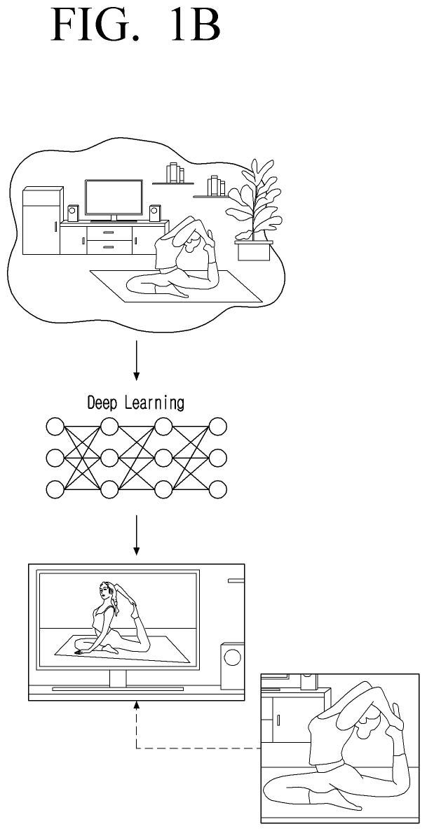

FIG. 1A is a schematic diagram of controlling a smart home device according to a preset scene in the related art. For example, a user presets a yoga exercise scene. Then, when it is detected that the user starts to do yoga exercise, a yoga exercise scene is entered, and a television set is controlled to be turned on to play a yoga teaching video. However, for this processing mode, a large number of scenes are required to be preset, where complex setting contents are required. Furthermore, during the scene setting process, the user also requirements to have a full understanding of the device, thereby causing setting difficulty.

FIG. 1B is a schematic diagram of controlling a smart home device according to deep learning in the related art. First, a user prepares a large amount of training data (for example, the training data includes: sensing data detecting that the user starts to do yoga exercise and a television turn-on instruction serving as a tag) to train a deep learning model, and controls the device based on the trained deep learning model. However, for this processing mode, a large amount of training data is required to be prepared, thereby causing high implementation difficulty and high cost.

In an embodiment of the present disclosure, an environmental factor to be controlled is determined, including but not limited to, a home environment where a user is located may be continuously monitored, changes in the home environment are automatically sensed, and the changed environmental factor is determined as the environmental factor to be controlled). An associated smart home device is screened according to the environmental factor to be controlled. According to current states of the screened smart home device and the environmental factor to be controlled, a query text is constructed for query to a large language model (LLM), and then a control instruction of the smart home device is generated according to a reply of the LLM. Further, feedback evaluations of the user for a control effect may also be collected, and user portraits and preferences may be formed by learning the feedback evaluations of the user, whereby the query text can be improved subsequently to further optimize the control effect.

The above disclosure describes in detail technical defects existing in the related art, the reasons leading to the technical defects, and the process of thinking and analysis to overcome the technical defects. The recognition of the above technical defects is not common knowledge in the art, but novel findings of the inventors in research. In addition, the reason tracing of the technical defects and the process of thinking and analysis to overcome the technical defects are both the stepwise analysis results of the inventors in the actual research process, and are not common knowledge in the art.

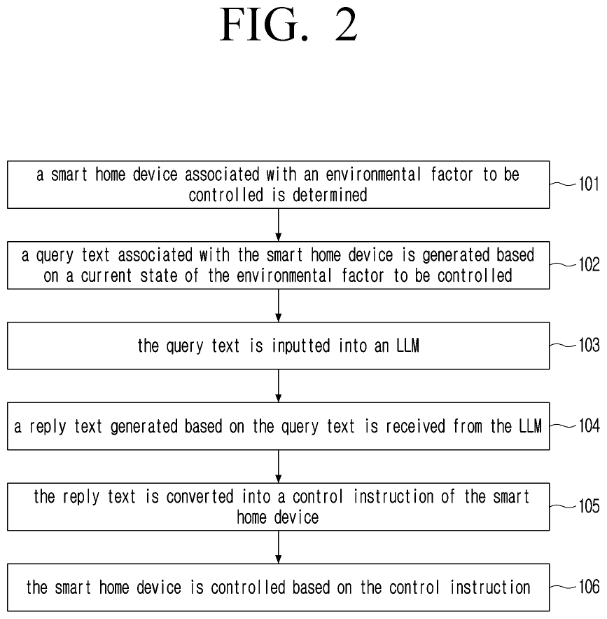

FIG. 2 is an example flowchart of a method for controlling a smart home device according to an embodiment of the present disclosure. The method shown in FIG. 2 may be performed by a control unit. For example, the control unit may be implemented as a controller integrated into a smart gateway of a smart home system, a stand-alone controller in the smart home system or a remote controller at the cloud, and the like. As shown in FIG. 2, the method may include the following operations.

In operation 101, a smart home device associated with an environmental factor to be controlled is determined.

Here, the environmental factor is a factor capable of characterizing a state of a smart home environment. For example, the environmental factor may include weather conditions, ground conditions, light conditions, air temperature conditions, humidity conditions, noise levels, access control states, smart home device states, home personnel states, and the like. There may be one or more environmental factors to be controlled. Preferably, the smart home device associated with the environmental factor to be controlled is a smart home device that is most associated with the environmental factor to be controlled.

In one embodiment, operation 101 includes the following operations.

(1) In response to receiving a description text containing a control target, a keyword is extracted from the control target, an environmental factor associated with the keyword is determined as the environmental factor to be controlled, and the smart home device associated with the environmental factor to be controlled is determined.

For example, a control purpose of a user, for example, “I want to watch a movie”, is expressed by a voice instruction, a gesture instruction, a text instruction, or a specific action instruction. A keyword “movie” is extracted from the control purpose “I want to watch a movie”, and an environmental factor (for example, a television set state) associated with the keyword “movie” is determined as an environmental factor to be controlled. Then, a smart home device associated with the environmental factor to be controlled is determined as a television set.

(2) In response to matching a preset rule or triggering a preset scene, an environmental factor associated with the rule or scene is determined as the environmental factor to be controlled, and the smart home device associated with the environmental factor to be controlled is determined.

Example 1: The user sets a rule: “Clean the floor after going out”. An environmental factor associated with the rule includes: “floor condition”. The environmental factor is determined as an environmental factor to be controlled. Then, a smart home device associated with the environmental factor to be controlled includes a sweeping robot.

Example 2: The user sets a scene: “home constant-temperature scene”. An environmental factor associated with the scene includes: “indoor temperature state”. Then the environmental factor is determined as an environmental factor to be controlled. Then, a smart home device associated with the environmental factor to be controlled includes an air conditioner.

(3) In response to an environmental factor characterizing a smart home environment being changed, the changed environmental factor is determined as the environmental factor to be controlled, and the smart home device associated with the environmental factor to be controlled is determined.

In one embodiment, in response to an environmental factor characterizing a smart home environment being changed, the method further includes: determining that the environmental factor characterizing the smart home environment is changed.

Specifically, the specific process for determining that the environmental factor characterizing the smart home environment is changed may include the following operations.

(3.1) A value of the environmental factor is determined based on a detection operation of a sensor disposed in the smart home environment or a reading operation of reading data from an environmental factor data source.

For example, various detection values may be obtained in real time from various environmental sensors (for example, a temperature sensor, a humidity sensor, an access control sensor, a noise sensor, and the like) in the smart home environment. As another example, a value of the environmental factor (for example, a temperature value of a weather forecast, a current date, and the like) may be read in real-time from one or more environmental factor data sources (for example, weather forecast websites, electronic calendars, and the like).

Furthermore, the detection operation of the sensors or the reading operation for the environmental factor data sources may be implemented as a Poll mechanism for periodic query (for example, a weather forecast is obtained once a day, a cleanliness analysis is performed on a floor image once an hour, and the like), and may also be implemented as a subscription mechanism (for example, alarms from a smoke alarm are actively subscribed, and the like).

(3.2) Based on a comparison process between the value and a plurality of preset value intervals, a value interval corresponding to the value is determined.

(3.3) A state of the environmental factor is determined based on the value interval corresponding to the value.

For example, when an indoor temperature is greater than 30 degrees Celsius, it is determined that the indoor temperature is high. When the indoor temperature is less than 15 degrees Celsius, it is determined that the indoor temperature is low. When the indoor temperature is more than 15 degrees Celsius and less than 30 degrees Celsius, it is determined that the indoor temperature is moderate, and so on.

(3.4) When the state is changed, it is determined that the environmental factor is changed.

For example, when the indoor temperature is changed from moderate to high, the indoor temperature is determined as the environmental factor to be controlled. For example, when an access control state is changed from locked state to unlocked state, the access control state is determined as the environmental factor to be controlled. For example, when a floor cleanliness state is changed from tidy to slightly dusty, the floor cleanliness is determined as the environmental factor to be controlled. For example, when a household personnel state is changed from nobody state to somebody state, the household personnel state is determined as the environmental factor to be controlled, and so on.

In one embodiment, the determining the smart home device associated with the changed environmental factor includes: determining description information of the changed environmental factor based on a name of the changed environmental factor and a current state of the changed environmental factor; converting the description information into a first vector; calculating correlations between the first vector and second vectors, where each of the second vectors is converted based on description information of a corresponding smart home device in the smart home environment; and determining a smart home device corresponding to the second vector having the maximum correlation as the smart home device associated with the changed environmental factor.

For example, the description information of the environmental factor may include: (1) a name of the environmental factor; and (2) a current state of the environmental factor. Example 1: “Weather” is the name of the environmental factor, and the description information thereof may be “hazy weather”, where “hazy” is the current state of the environmental factor “weather”. Example 2: “Floor” is the name of the environmental factor, and the description information thereof may be “dusty floor”, where “dusty” is the current state of the environmental factor “floor”.

The description information of the changed environmental factor may be converted into a first vector by a vector conversion tool (for example, word2vec).

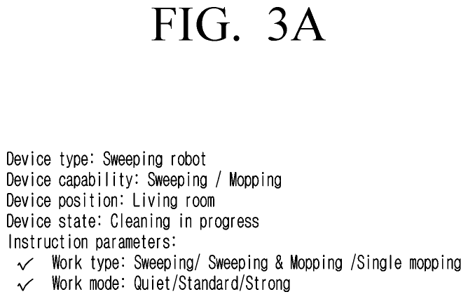

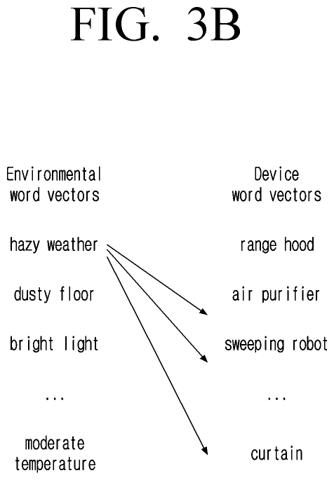

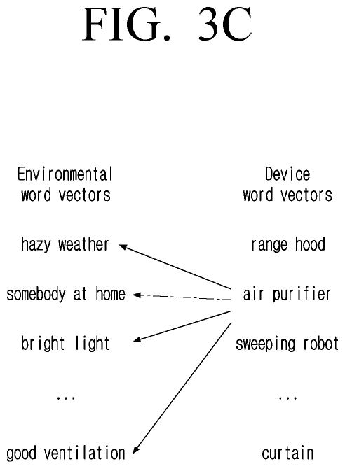

For example, the description information of the smart home device may include: (1) device type; (2) device capability; (3) device position; (3) device state; (4) device parameter, and the like. FIG. 3A is an example schematic diagram of description information of a smart home device according to an embodiment of the present disclosure. Description information of a sweeping robot is exemplarily shown.

Description information of each smart home device in a smart home environment may be obtained in advance. Then, the description information of each smart home device is converted into a second vector by the vector conversion tool (for example, word2vec).

Next, correlations between the first vector and the second vectors are calculated (for example, association vectors between the first vector and the second vectors are calculated through a vector dot product algorithm, and then the correlation vectors are normalized (for example, using a SoftMax operator) to obtain a probability distribution). A smart home device corresponding to the second vector having the maximum correlation (for example, maximum probability distribution) with the first vector is determined as the smart home device associated with the changed environmental factor.

Typical examples of determining the smart home device associated with the changed environmental factor are described below.

First, a word vector model is trained on text data accumulated in the field of smart home using tools such as word2vec. Based on the word vector model, common description texts of various smart devices and description texts of various environmental factors are converted into word vectors.

For example, description information of environmental factors detected in a current smart home platform includes: (hazy weather, dusty floor, bright light, moderate temperature, and the like), and the corresponding word vectors are: (E1, E2, E3, E4, . . . ). The smart devices connected to the network in the current smart home platform include: (range hood, air purifier, sweeping robot, curtain, and the like), and the corresponding word vectors are: (D1, D2, D3, D4, . . . ).

Then, for a specific environmental factor (for example, a certain changed environmental factor), such as hazy weather, a word vector E1 is first searched. Then, correlations (R1, R2, R3, R4, . . . ) between E1 and the word vectors (D1, D2, D3, D4, . . . ) of the devices are calculated by cosine and other functions. Next, these correlations (R1, R2, R3, R4, . . . ) are normalized by SoftMax and other functions to obtain a correlation probability distribution (P1, P2, P3, P4, . . . ) of the environmental factor with respect to a current device group, where Σ(P1, P2, P3, P4, . . . )=1. For example, the probability distribution of the environmental factor (hazy weather) with respect to the current device group (range hood, air purifier, sweeping robot, and curtain) is: (0.05, 0.7, 0.15, 0.1). According to a preset activation threshold (for example, 0.4), it may be determined that the most associated device is the air purifier when the weather changes from sunny to hazy.

FIG. 3B is an example schematic diagram of determining a smart home device associated with an environmental factor to be controlled according to an embodiment of the present disclosure. In FIG. 3B, a hazy weather has an association with an air purifier, a sweeping robot and a curtain, and has the maximum association with the air purifier (characterized by the maximum width of a connection arrow). Therefore, it is determined that a device most associated with the hazy weather is the air purifier.

In operation 102, a query text associated with the smart home device is generated based on a current state of the environmental factor to be controlled.

Here, a query text that conforms to a current scene is automatically constructed as an input of the LLM through the accurately screened device and the current state of the environmental factor to be controlled. According to the characteristics of the LLM, a query text template suitable for generating a decision-making output may be constructed in advance.

Information such as the type, position, capability, and state of the smart home device associated with the environmental factor to be controlled may be queried as a device input. The current state of the environmental factor to be controlled may also be queried as an environmental input. The device input and the environmental input are then filled into the query text template, and a query text that is targeted and accurate for current environmental changes may be constructed.

Exemplarily, the query text template may include:

(1) Query Text Template 1: configured for querying whether to start the smart home device under the current environmental state.

The query text template 1 may contain a user state or not.

In one embodiment, in the case that the user state is not contained, a specific structure 1 of the query text template 1, includes: “in {environmental state 1}, {environmental state 2}, . . . , {environmental state n} now, in this case, querying whether to start a{smart home device} in the {smart home device state 1 (for example, position)}, {smart home device state 2 (for example, remaining power)}, . . . , {smart home device state p} to achieve {expected environmental result}?”.

In one embodiment, in the case that the user state is contained, a specific structure 2 of the query text template 1 includes: “in {environmental state 1}, {environmental state 2}, . . . , {environmental state n}, {user state 1}, {user state 2}, . . . , {user state m} now, in this case, querying whether to start a {smart home device} in the {smart home device state 1 (for example, position)}, {smart home device state 2 (for example, remaining power)}, . . . {smart home device state p} to achieve {expected environmental result}?”.

(2) Query Text Template 2: configured for determining operating parameters of the smart home device under the current environmental state.

The query text template 2 may contain a user state or not.

In one embodiment, in the case that the user state is not contained, a specific structure 1 of the query text template 2, is: “in {environmental state 1}, {environmental state 2}, . . . , {environmental state n} now, how to control {smart home device} in {smart home device state 1 (for example, position)}, {smart home device state 2 (for example, remaining power)}, . . . , {smart home device state p} now to achieve {expected environmental result}?”.

In one embodiment, in the case that the user state is contained, a specific structure 2 of the query text template 2, is: “in {environmental state 1}, {environmental state 2}, . . . , {environmental state n}, {user state 1}, {user state 2}, . . . , {user state m} now, how to control {smart home device} in {smart home device state 1 (for example, position)}, {smart home device state 2 (for example, remaining power)}, . . . , {smart home device state p} now to achieve {expected environmental result of user}?”.

The contents and number of { } in the above templates are optional and editable.

In one embodiment, operation 102 includes the following operations.

(1) A current state of the smart home device associated with the changed environmental factor is determined, and a query text containing a query whether to start the smart home device associated with the changed environmental factor is generated based on the current state of the changed environmental factor and the current state of the smart home device associated with the changed environmental factor.

For example, it is assumed that the device input is {device: air purifier, state: off, position: living room, . . . } and the environmental factor is {weather: hazy}, which are filled in the structure 1 of the query text template 1 to construct a query text: “Turn on or not an air purifier that has been turned off in a living room to achieve air safety in the current hazy weather?”.

(2) A current state of the smart home device associated with the changed environmental factor is determined, and a query text containing a query for control parameters of the smart home device associated with the changed environmental factor is generated based on the current state of the changed environmental factor and the current state of the smart home device associated with the changed environmental factor.

For example, it is assumed that the device input is {device: air purifier, state: off, position: living room, . . . } and the environmental factor is {weather: hazy}, which are filled in the structure 1 of the query text template 2 to construct a query text: “How to control an air purifier that has been turned off in a living room to achieve air safety in the current hazy weather?”.

(3) A current state of the smart home device associated with the changed environmental factor and a state of a user in the smart home environment are determined, and a query text containing a query whether to start the smart home device associated with the changed environmental factor to meet requirements of the user is generated based on the current state of the changed environmental factor, the current state of the smart home device associated with the changed environmental factor and the state of the user.

For example, it is assumed that the device input is {device: air purifier, state: off, position: living room, . . . }, the environmental factor is {weather: hazy}, and the state of the user is {user name: user A, home state: at home, demand: an air quality index is expected to be lower than 50, . . . }, which are filled in the structure 2 of the query text template 1 to construct a query text: “Turn on or not an air purifier that has been turned off in a living room to achieve an expectation of user A that an air quality index is lower than 50 when user A is at home in the current hazy weather?”.

(4) A current state of the smart home device associated with the changed environmental factor and a state of a user in the smart home environment are determined, and a query text containing a query for control parameters of the smart home device associated with the changed environmental factor to meet requirements of the user is generated based on the current state of the changed environmental factor, the current state of the smart home device associated with the changed environmental factor and the state of the user.

For example, it is assumed that the device input is {device: air purifier, state: off, position: living room, . . . }, the environmental factor is {weather: hazy, home: somebody, . . . }, and the state of the user is {user name: user A, home state: at home, demand: an air quality index is expected to be lower than 50, . . . }, which are filled in the structure 2 of the query text template 2 to construct a query text: “How to control an air purifier that has been turned off in a living room to achieve an expectation of user A that an air quality index is lower than 50 when user A is at home in the current hazy weather?”.

Typical examples of generating a query statement based on a changed environmental factor and a smart home device associated with the changed environmental factor have been described above in detail. Considering that the smart home device associated with the changed environmental factor may further affect other environmental factors, the accuracy and comprehensiveness of the query statement can be further improved if these other environmental factors are added to the process of generating the query statement.

In one embodiment, the method includes: converting description information of the smart home device associated with the changed environmental factor into a third vector; calculating correlations between the third vector and fourth vectors, where each of the fourth vectors is converted based on description information of a corresponding environmental factor in the smart home environment; and determining an environmental factor associated with the changed environmental factor based on the environmental factor corresponding to the fourth vector having the correlation greater than a predetermined threshold.

FIG. 3C is an example schematic diagram of an environmental factor associated with a changed environmental factor according to an embodiment of the present disclosure. In FIG. 3C, a device associated with a changed environmental factor is an air purifier, and the air purifier has an association with environmental factors: “hazy weather”, “somebody at home”, “bright light”, and “good ventilation”, and has a maximum correlation with “hazy weather” (characterized by the maximum width of a connection arrow). It is assumed that the correlation with “hazy weather” is 0.5, the correlation with “somebody at home” is 0.3, the correlation with “bright light” is 0.1, the correlation with “good ventilation” is 0.1, and a predetermined threshold is 0.25. Then, it is determined that the environmental factor associated with the changed environmental factor (“hazy weather”) is: “somebody at home” from environmental factors “hazy weather” and “somebody at home” which are greater than the threshold.

In one embodiment, operation 102 includes the following operations.

(1) A current state of the smart home device associated with the changed environmental factor and a current state of the environmental factor associated with the changed environmental factor are determined, and a query text containing a query whether to start the smart home device associated with the changed environmental factor is generated based on the current state of the changed environmental factor, the current state of the smart home device associated with the changed environmental factor and the current state of the environmental factor associated with the changed environmental factor.

Accordingly, since there are a plurality of environmental factors in the template (in other words, a changed environmental factor and an environmental factor associated with the changed environmental factor), the specific structure 1 of the query text template 1 is changed to: “in {environmental state 1 of environmental factor 1}, {environmental state 2 of environmental factor 1}, . . . , {environmental state n of environmental factor 1}, {environmental state 1 of environmental factor 2}, {environmental state 2 of environmental factor 2}, . . . , {environmental state m of environmental factor 2}, in this case, querying whether to start {smart home device} in {smart home device state 1 (for example, position)}, {smart home device state 2 (for example, remaining power)}, . . . , {smart home device state p} now to achieve {expected environmental result}?”. For example, it is assumed that the changed environmental factor is {weather: hazy} and the environmental factor associated with the changed environmental factor is {home: somebody}, which are filled in the specific structure 1 of the query text template 1 to construct a query text: “Start or not an air purifier that has been turned off in a living room to reduce air pollution when somebody is at home in the current hazy weather?”.

(2) A current state of the smart home device associated with the changed environmental factor and a current state of the environmental factor associated with the changed environmental factor are determined, and a query text containing a query for control parameters of the smart home device associated with the changed environmental factor is generated based on the current state of the changed environmental factor, the current state of the smart home device associated with the changed environmental factor and the current state of the environmental factor associated with the changed environmental factor.

Accordingly, since there are a plurality of environmental factors in the template, the specific structure 1 of the query text template 2 includes: “in {environmental state 1 of environmental factor 1}, {environmental state 2 of environmental factor 1}, . . . , {environmental state n of environmental factor 1}, {environmental state 1 of environmental factor 2}, {environmental state 2 of environmental factor 2}, . . . , {environmental state m of environmental factor 2}, in this case, how to control {smart home device} in {smart home device state 1 (for example, position)}, {smart home device state 2 (for example, remaining power)}, . . . , {smart home device state p} now to achieve {expected environmental result}?”. For example, it is assumed that the changed environmental factor is {weather: hazy}, and the environmental factor associated with the changed environmental factor is: {home: somebody}, which are filled into the specific structure 1 of the query text template 2 to construct a query text: “How to control an air purifier that has been turned off in a living room to keep an air index in a healthy level when somebody is at home in the current hazy weather?”.

(3) A current state of the smart home device associated with the changed environmental factor, a current state of the environmental factor associated with the changed environmental factor and a state of a user in the smart home environment are determined, and a query text containing a query whether to start the smart home device associated with the changed environmental factor to meet requirements of the user is generated based on the current state of the changed environmental factor, the current state of the smart home device associated with the changed environmental factor, the current state of the environmental factor associated with the changed environmental factor, and the state of the user.

Accordingly, since there are a plurality of environmental factors in the template, the specific structure 2 of the query text template 1 includes: “in {environmental state 1 of environmental factor 1}, {environmental state 2 of environmental factor 1}, . . . , {environmental state n of environmental factor 1}, {environmental state 1 of environmental factor 2}, {environmental state 2 of environmental factor 2}, . . . , {environmental state m of environmental factor 2}, . . . , {user state 2}, . . . , {user state m}, in this case, querying whether to start {smart home device} in {smart home device state 1 (for example, position)}, {smart home device state 2 (for example, remaining power)}, . . . , {smart home device state p} now to achieve {expected environmental result of user A}?”. For example, it is assumed that the changed environmental factor is {weather: hazy}, and the environmental factor associated with the changed environmental factor is: {home: somebody}, which are filled in the specific structure 2 of the query text template 1 to construct a query text: “Start or not an air purifier that has been turned off in a living room to achieve an expectation of user A that an air quality index is lower than 40 when user A is at home in the current hazy weather?”.

(4) A current state of the smart home device associated with the changed environmental factor, a current state of the environmental factor associated with the changed environmental factor and a state of a user in the smart home environment are determined, and a query text containing a query for control parameters of the smart home device associated with the changed environmental factor to meet requirements of the user is generated based on the current state of the changed environmental factor, the current state of the smart home device associated with the changed environmental factor, the current state of the environmental factor associated with the changed environmental factor, and the state of the user.

Accordingly, since there are a plurality of environmental factors in the template, the specific structure 2 of the query text template 2 includes: “in {environmental state 1 of environmental factor 1}, {environmental state 2 of environmental factor 1}, . . . , {environmental state n of environmental factor 1}, {environmental state 1 of environmental factor 2}, {environmental state 2 of environmental factor 2}, . . . , {environmental state m of environmental factor 2}, . . . , {user state 1}, {user state 2}, . . . , {user state m}, how to control {smart home device} in {smart home device state 1 (for example, position)}, {smart home device state 2 (for example, remaining power)}, . . . , {smart home device state p} now to achieve {expected environmental result of user A}?”. For example, it is assumed that the changed environmental factor is {weather: hazy}, and the environmental factor associated with the changed environmental factor is: {home: somebody}, which are filled in the specific structure 2 of the query text template 2 to construct a query text: “How to control an air purifier that has been turned off in a living room to achieve an expectation of user A that an air quality index is lower than 40 when user A is at home in the current hazy weather?”.

Therefore, by further adding the current state of the environmental factor associated with the changed environmental factor to the query text, the query text may be generated based on a plurality of environmental factors, thereby improving the accuracy and comprehensiveness of the query text, and facilitating accurate understanding of the user intentions by the LLM.

In operation 103, the query text is inputted into an LLM.

The LLM refers to a deep learning model that is trained using a large amount of text data to generate a natural language text or understand the meaning of the language text. The LLM may process a variety of natural language tasks such as text categorization, question answering, and dialog. At present, the LLM usually adopts a Transformer architecture and a pre-training target (such as Language Modeling) similar to a small model. The difference from the small model is that the model size, training data and computing resources are increased. For example, the LLM may be implemented as ChatGPT, DGPT-4, Claude, LLaMA, or Anthropic-LM, and the like.

In operation 104, a reply text generated based on the query text is received from the LLM.

In operation 105, the reply text is converted into a control instruction of the smart home device.

Here, the reply text may be converted into the control instruction of the smart home device based on an existing or later newly developed instruction conversion process in the related art.

In operation 106, the smart home device is controlled based on the control instruction.

In one embodiment, prior to operations 105 and 106, the control instruction is further sent to the user for confirmation, thereby reducing the probability of disoperation. Optionally, instead of sending the control instruction to the user for confirmation, the smart home device may be controlled directly based on the control instruction, thereby achieving seamless control.

In one embodiment, after operation 106, the method further includes: receiving a feedback of the user on a control effect; and adjusting the requirements of the user based on the feedback. Here, user portraits and preferences are formed by learning user evaluations to improve the query text, whereby the purpose of optimizing the control effect can be achieved.

Examples: After the LLM is queried based on the query text: “How to control an air purifier to achieve that an air quality index is lower than 50 in the current hazy weather?”, if a received user feedback indicates that the user is not satisfied with this adjusted air quality index, a demand in the state of the user: {user: user A, state: at home, demand: the air quality index is expected to be lower than 50, . . . } may be changed to: the air quality index is expected to be lower than 40. Then, when the query text is generated again in the same subsequent scene, the query text is updated to: “How to control an air purifier to achieve that an air quality index is lower than 40 in the current hazy weather?”. Therefore, the control can be enhanced to decrease the air quality index, so as to meet requirements of the user.

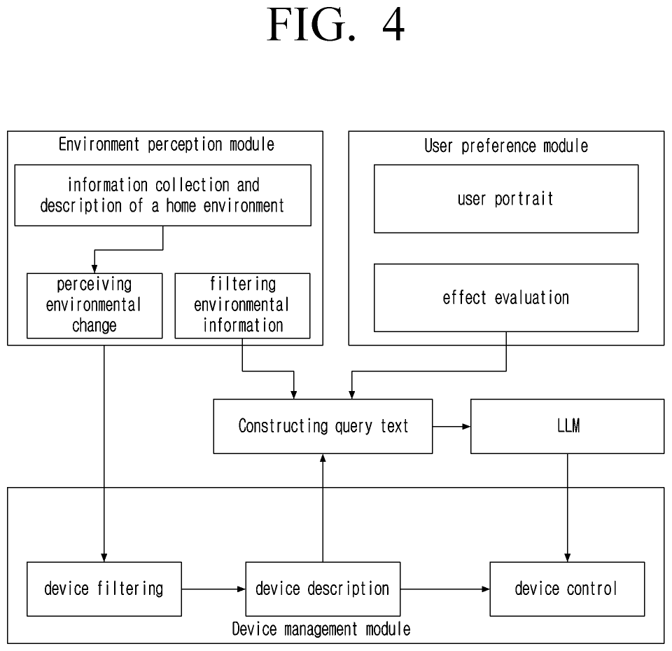

FIG. 4 is a modularized schematic diagram of a process for controlling a smart home device according to an embodiment of the present disclosure. An environment perception module is configured to perform information collection and description of a home environment, perceive an environmental change based on the information collection, determine a changed environmental factor based on the environmental change, and perform information filtering on the changed environmental factor (determination of a current state). The description information of all smart home devices is pre-stored in a device management module. The device management module is configured to perform device filtering (filtering a smart home device associated with the environmental factor) based on the changed environmental factor and the description information of all the smart home devices. A query text is constructed based on the smart home device associated with the environmental factor and the current state of the changed environmental factor. The query text is inputted into an LLM. The device management module performs device control based on a reply text for the query text of the LLM. In a user preference module, control effect evaluations and/or user portraits are determined. The query text is improved based on the control effect evaluations and/or the user portraits, whereby the control effect is further optimized.

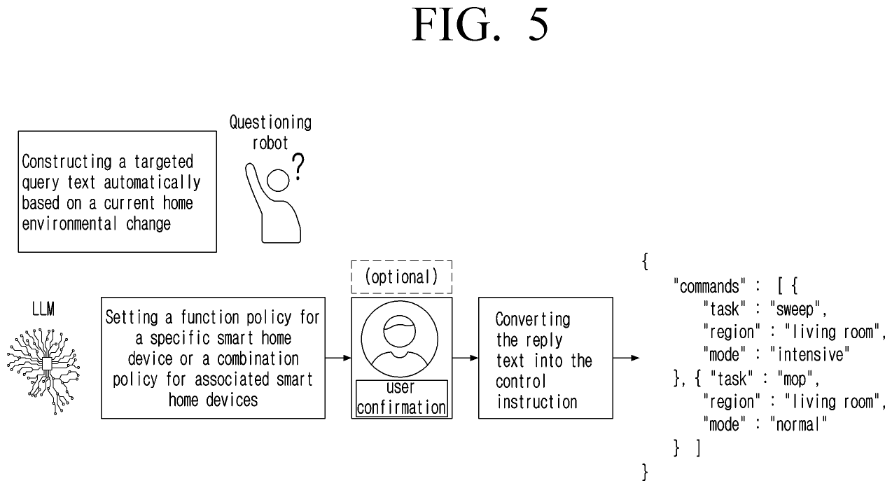

FIG. 5 is an example schematic diagram of a process for controlling a smart home device according to an embodiment of the present disclosure. As shown in FIG. 5, a targeted query text is automatically constructed based on a current home environmental change. A function policy for a specific smart home device or a combination policy for associated smart home devices may be set in the LLM. Optionally, the reply text outputted for the LLM may be confirmed by the user. After confirmation of the user, the reply text is converted into a control instruction.

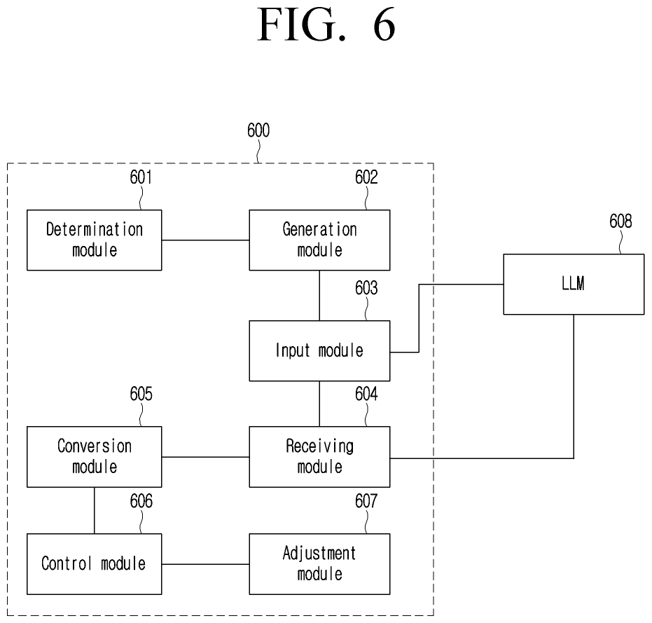

FIG. 6 is an example structural diagram of an apparatus for controlling a smart home device according to an embodiment of the present disclosure. As shown in FIG. 6, an apparatus 600 for controlling a smart home device includes: a determination module 601, configured to determine a smart home device associated with an environmental factor to be controlled; a generation module 602, configured to generate a query text associated with the smart home device based on a current state of the environmental factor to be controlled; an input module 603, configured to input the query text into an LLM 608; a receiving module 604, configured to receive a reply text generated based on the query text from the LLM 608; a conversion module 605, configured to convert the reply text into a control instruction of the smart home device; and a control module 606, configured to control the smart home device based on the control instruction.

At least one of the components, elements, modules and units (collectively “components” in this paragraph) represented by a block in the drawings such as FIG. 6, may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU), a microprocessor, or the like that performs the respective functions.

In one embodiment, the determination module 601 is configured to: determine, in response to an environmental factor characterizing a smart home environment being changed, the changed environmental factor as the environmental factor to be controlled, and determine the smart home device associated with the environmental factor to be controlled; or extract, in response to receiving a description text containing a control target, a keyword from the control target, determine an environmental factor associated with the keyword as the environmental factor to be controlled, and determine the smart home device associated with the environmental factor to be controlled; or determine, in response to matching a preset rule or triggering a preset scene, an environmental factor associated with the rule or the scene as the environmental factor to be controlled, and determine the smart home device associated with the environmental factor to be controlled.

In one embodiment, the determination module 601 is configured to: determine description information of the changed environmental factor based on a name of the changed environmental factor and a current state of the changed environmental factor; convert the description information into a first vector; calculate correlations between the first vector and second vectors, where each of the second vectors is converted based on description information of a corresponding smart home device in the smart home environment; and determine a smart home device corresponding to the second vector having the maximum correlation as the smart home device associated with the changed environmental factor.

In one embodiment, the generation module 602 is configured to: determine a current state of the smart home device associated with the changed environmental factor, and generate, based on the current state of the changed environmental factor and the current state of the smart home device associated with the changed environmental factor, a query text containing a query whether to start the smart home device associated with the changed environmental factor; or determine a current state of the smart home device associated with the changed environmental factor, and generate, based on the current state of the changed environmental factor and the current state of the smart home device associated with the changed environmental factor, a query text containing a query for control parameters of the smart home device associated with the changed environmental factor; or determine a current state of the smart home device associated with the changed environmental factor and a state of a user in the smart home environment, and generate, based on the current state of the changed environmental factor, the current state of the smart home device associated with the changed environmental factor and the state of the user, a query text containing a query whether to start the smart home device associated with the changed environmental factor to meet requirements of the user; or determine a current state of the smart home device associated with the changed environmental factor and a state of a user in the smart home environment, and generate, based on the current state of the changed environmental factor, the current state of the smart home device associated with the changed environmental factor and the state of the user, a query text containing a query for control parameters of the smart home device associated with the changed environmental factor to meet requirements of the user.

In one embodiment, the determination module 601 is configured to: convert description information of the smart home device associated with the changed environmental factor into a third vector; calculate correlations between the third vector and each of fourth vectors, where each of the fourth vectors is converted based on description information of a corresponding environmental factor in the smart home environment; and determine an environmental factor associated with the changed environmental factor based on the environmental factor corresponding to the fourth vector having the correlation greater than a predetermined threshold.

In one embodiment, the generation module 602 is configured to: determine a current state of the smart home device associated with the changed environmental factor and a current state of the environmental factor associated with the changed environmental factor, and generate, based on the current state of the changed environmental factor, the current state of the smart home device associated with the changed environmental factor and the current state of the environmental factor associated with the changed environmental factor, a query text containing a query whether to start the smart home device associated with the changed environmental factor; or determine a current state of the smart home device associated with the changed environmental factor and a current state of the environmental factor associated with the changed environmental factor, and generate, based on the current state of the changed environmental factor, the current state of the smart home device associated with the changed environmental factor and the current state of the environmental factor associated with the changed environmental factor, a query text containing a query for control parameters of the smart home device associated with the changed environmental factor; or determine a current state of the smart home device associated with the changed environmental factor, a current state of the environmental factor associated with the changed environmental factor and a state of a user in the smart home environment, and generate, based on the current state of the changed environmental factor, the current state of the smart home device associated with the changed environmental factor, the current state of the environmental factor associated with the changed environmental factor, and the state of the user, a query text containing a query whether to start the smart home device associated with the changed environmental factor to meet requirements of the user; or determine a current state of the smart home device associated with the changed environmental factor, a current state of the environmental factor associated with the changed environmental factor and a state of a user in the smart home environment, and generate, based on the current state of the changed environmental factor, the current state of the smart home device associated with the changed environmental factor, the current state of the environmental factor associated with the changed environmental factor, and the state of the user, a query text containing a query for control parameters of the smart home device associated with the changed environmental factor to meet requirements of the user.

In one embodiment, the apparatus further includes: an adjustment module 607, configured to: receive a feedback of the user on a control effect; and adjust the requirements of the user based on the feedback.

Typical application scenes for embodiments of the present disclosure are described below.

### Application Scene 1: a Smart Home Device is Controlled Based on Environmental Monitoring.

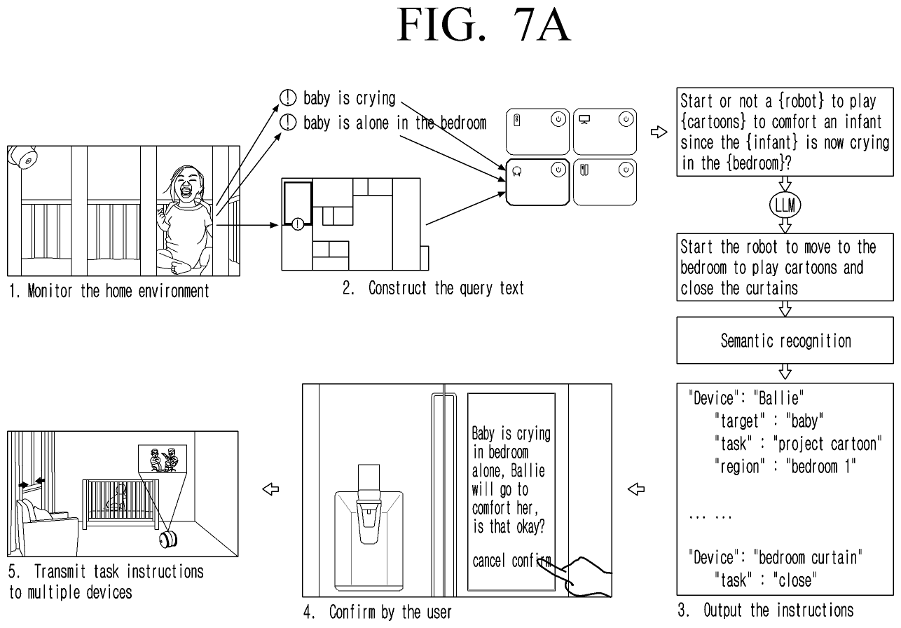

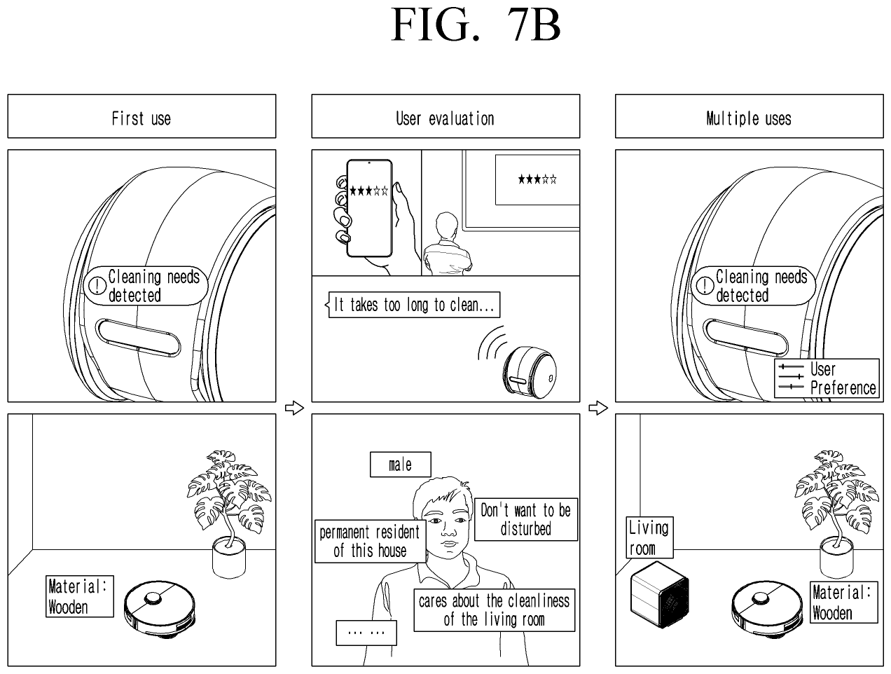

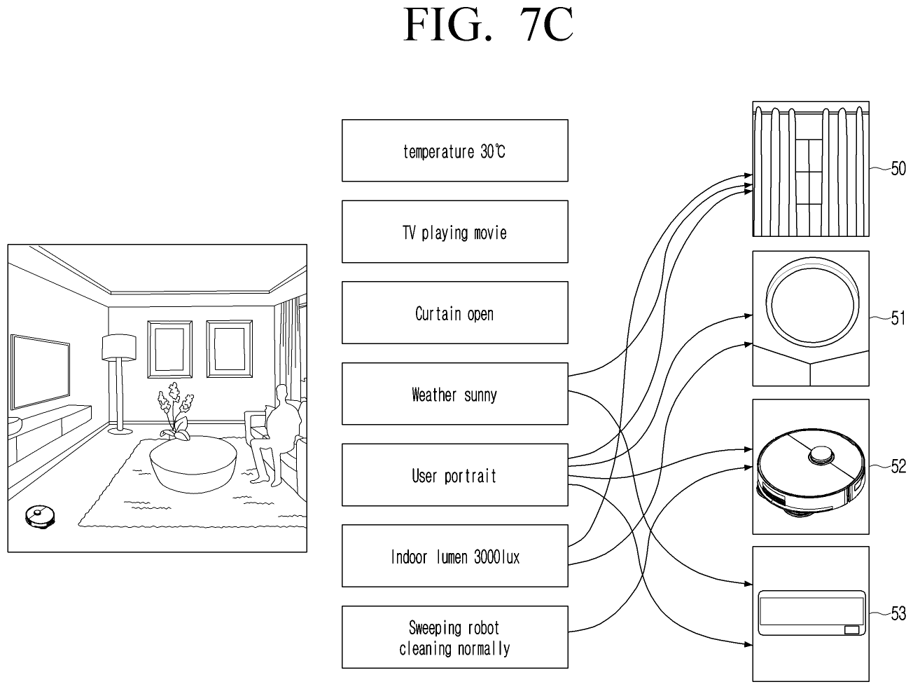

FIG. 7A is a first example schematic diagram of controlling a smart home device according to an embodiment of the present disclosure. In FIG. 7A, it is detected by a camera that an environmental factor is changed: (1) an infant is changed from sleeping to crying; and (2) light brightness is changed from moderate to too high. The smart home device most associated with the environmental factor (1) is queried as a robot. The smart home device most associated with the environmental factor (2) is queried as a curtain. Based on the current state of the environmental factor 1 (infant crying), the state of the user (in bedroom) and the state of the robot, a query text 1 is generated: “Start or not a robot in a living room to move to a bedroom to play cartoons to comfort an infant since the infant is now crying in the bedroom?”. Based on the current state of the environmental factor 2 (bright), the state of the user (in bedroom) and the state of the curtain, a query text 2 is generated: “How to control a curtain to reduce the brightness since the brightness is now too high?”. The query text 1 and the query text 2 are inputted into the LLM, and reply texts returned by the LLM are converted into instructions for controlling the robot and the curtain.

### Application Scene 2: The Generation of a Query Text is Adjusted Based on a User Feedback.

FIG. 7B is a second example schematic diagram of controlling a smart home device according to an embodiment of the present disclosure. In FIG. 7B, a query text for a sweeping robot is: “How to control the sweeping robot to achieve cleanliness of 80% expected by user A when user A is at home since the floor is heavily dusty currently”. The query text is inputted into the LLM, and a reply text returned by the LLM is converted into an instruction for controlling the sweeping robot. Then, a feedback of the user on this control effect (for example, voice receiving) is received, and it is shown that the user is not satisfied with the cleanliness of this cleaning. Then, the requirements of user A are adjusted to: cleanliness of 90%. Then, when the floor is heavily dusty next time and user A is at home, the query text is changed to: “How to control the sweeping robot to achieve cleanliness of 90% expected by user A when user A is at home since the floor is heavily dusty currently”, the changed query text is inputted into the LLM, and the updated reply text returned by the LLM is converted into an instruction for controlling the sweeping robot.

### Application Scene 3: Device Filtering

FIG. 7C is a schematic diagram of determining a smart home device associated with an environmental factor to be controlled according to an embodiment of the present disclosure. In FIG. 7C, it is detected that an environmental factor (for example, detecting user activities via a camera and detecting an indoor environment based on a sensor) is changed as follows: (1) the indoor lumen is changed; (2) the curtain is changed; (3) the floor cleanliness is changed; and (4) the temperature is changed. It is determined that a smart home device associated with change (1) is a light device, a smart home device associated with change (2) is a curtain, a smart home device associated with change (3) is a sweeping robot, and a smart home device associated with change (4) is an air conditioner. Then, respective associated smart home devices of the light device, the curtain, the sweeping robot, and the air conditioner are determined. Next, a query text of the light device is generated using the current state of the indoor lumen, the state of the light device, and the state of the smart home device associated with the light device. Similarly, query texts of the curtain, the sweeping robot and the air conditioner are generated. The respective query texts of the light device, the curtain, the sweeping robot, and the air conditioner are inputted into the LLM, and the corresponding reply texts returned by the LLM are converted into control instructions for the light device, the curtain, the sweeping robot, and the air conditioner, respectively.

In summary, in the embodiments of the present disclosure, a smart home device associated with an environmental factor to be controlled is determined; a query text associated with the smart home device is generated based on a current state of the environmental factor to be controlled; the query text is inputted into an LLM; a reply text generated based on the query text is received from the LLM; the reply text is converted into a control instruction of the smart home device; and the smart home device is controlled based on the control instruction. It can be seen therefrom that in the embodiments of the present disclosure, an accurate query text is generated through the current state of the environmental factor to be controlled, and the LLM can be assisted in accurately understanding user intentions, so as to autonomously control the device as the environment changes. Complex scene or rule presetting is not required, and reliance on training data is also reduced, thereby reducing implementation difficulties and costs. The smart home device can be controlled conveniently, and a control effect can be optimized. Furthermore, the query text may be generated based on a plurality of environmental factors, thereby improving the accuracy and comprehensiveness of the query text, and facilitating accurate understanding of the user intentions by the LLM. In addition, user portraits and preferences are formed by user evaluations to improve the query text, whereby the control effect can be further optimized.

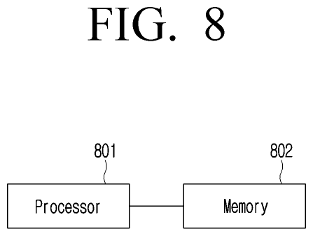

Embodiments of the present disclosure also provide an electronic device having a processor-memory architecture. FIG. 8 is a structural diagram of an electronic device according to an embodiment of the present disclosure. As shown in FIG. 8, the electronic device includes a processor 801, a memory 802, and a computer program stored in the memory 802 and executable on the processor 801. The computer program, when executed by the processor 801, implements the method for controlling a smart home device as described in any one of the above. The memory 802 may be specifically implemented as various storage media such as an electrically erasable programmable read-only memory (EEPROM), a flash memory, and a programmable program read-only memory (PROM). The processor 801 may be implemented as including one or more central processing units or one or more field programmable gate arrays. The field programmable gate arrays are integrated with one or more central processing unit cores. Specifically, the central processing unit or central processing unit core can be implemented as a CPU, an MCU, or a DSP.

It should be noted that not all the steps, operations, and modules in the above flowcharts and structural diagrams are necessary, and some steps or modules may be omitted according to actual requirements. The order of execution of the steps is not fixed and may be adjusted as required. The division of various modules is merely to facilitate the description of the functional division adopted. In an actual implementation, one module may be divided into a plurality of modules, the functions of the plurality of modules may also be realized by the same module, and these modules may be located in the same device or in different devices.

Hardware modules in various embodiments may be implemented mechanically or electronically. For example, one hardware module may include a specially designed permanent circuit or logic device (for example, a dedicated processor such as an FPGA or an ASIC) for performing a particular operation. The hardware module may also include a programmable logic device or circuit (for example, including a general purpose processor or other programmable processors) temporarily configured by software for performing a particular operation. The implementation of the hardware module mechanically, or using a dedicated permanent circuit, or using a temporarily configured circuit (for example, configured by software) may be determined based on cost and time considerations.

The present disclosure also provides a machine-readable storage medium storing instructions for causing a machine to perform the method as described herein. Specifically, a system or apparatus equipped with a storage medium may be provided. A software program code that realizes the functions of any one embodiment in the above examples is stored in the storage medium, and a computer (or a CPU or an MPU) of the system or apparatus is caused to read out and execute the program code stored in the storage medium. Furthermore, some or all of actual operations may be completed by an operating system or the like operating on the computer through instructions based on the program code. The program code read out from the storage medium may also be written into a memory provided in an expansion board inserted into the computer or into a memory provided in an expansion unit connected to the computer. Then, the instructions based on the program code cause the CPU or the like installed on the expansion board or the expansion unit to perform some or all of the actual operations, so as to realize the functions of any one of the above embodiments. Embodiments of the storage medium for providing the program code include a floppy disk, a hard disk, a magneto-optical disk, an optical disk (for example, CD-ROM, CD-R, CD-RW, DVD-ROM, DVD-RAM, DVD-RW, DVD+RW), a magnetic tape, a non-volatile memory card, and a ROM. Optionally, the program code may be downloaded from a server computer or cloud via a communication network.

As used herein, “schematic” means “serving as an instance, example, or description”, and any illustration and embodiment described herein as “schematic” should not be construed as a more preferred or advantageous technical solution. For sake of clarity of the drawings, only portions of the drawings related to the present disclosure are schematically shown and are not representative of an actual structure of a product. In addition, for sake of clarity of the drawings and ease of understanding, only one of members having the same structure or function may be schematically shown or marked in some of the drawings. As used herein, “one” does not mean to limit the number of related portions of the present disclosure to “only one”, and “one” does not mean to exclude the case that the number of related portions of the present disclosure is “more than one”. As used herein, “upper”, “lower”, “front”, “back”, “left”, “right”, “inner”, “outer”, and the like are used merely to indicate relative positional relationships between related portions, and do not limit absolute positions of these related portions.

The above description is merely preferred examples of the present disclosure and is not intended to limit the scope of protection of the present disclosure. Any modifications, equivalent substitutions, improvements, and the like made within the spirit and principles of the present disclosure are intended to be included within the scope of protection of the present disclosure.

What is claimed is:

1. A method for controlling a smart home device, the method comprising:
determining a smart home device that is associated with an environmental factor to be controlled;
generating a query associated with the smart home device based on a current state of the environmental factor to be controlled;
inputting the query into a large language model;
obtaining a reply generated based on the query from the large language model;
converting the reply from the large language model into a control instruction for the smart home device; and
controlling the smart home device based on the control instruction.

2. The method according to claim 1, wherein the determining the smart home device that is associated with the environmental factor to be controlled comprises one of:
determining, based on an environmental factor characterizing a smart home environment being changed, the environmental factor characterizing the smart home environment as the environmental factor to be controlled;
extracting, based on a description of a control target, a keyword from the control target, and determining an environmental factor associated with the keyword as the environmental factor to be controlled; and
determining, based on a predetermined condition being satisfied, an environmental factor associated with the predetermined condition as the environmental factor to be controlled.

3. The method according to claim 2, further comprising:
determining that the environmental factor characterizing the smart home environment is changed,
wherein the determining that the environmental factor characterizing the smart home environment is changed comprises:
determining a value of the environmental factor characterizing the smart home environment based on an operation of a sensor disposed in the smart home environment or based on reading data from an environmental factor data source;
determining, based on the value of the environmental factor characterizing the smart home environment and a plurality of preset value intervals, a value interval corresponding to the value of the environmental factor characterizing the smart home environment;
determining a state of the environmental factor characterizing the smart home environment based on the value interval; and
determining that the environmental factor is changed based on the state of the environmental factor characterizing the smart home environment.

4. The method according to claim 2, wherein the determining the smart home device that is associated with the changed environmental factor comprises:
determining description information of the environmental factor characterizing a smart home environment based on a name of the environmental factor characterizing a smart home environment and a current state of the environmental factor characterizing the smart home environment;
converting the description information into a first vector;
determining correlations between the first vector and one or more second vectors, wherein each of the one or more second vectors is based on description information of a corresponding smart home device in the smart home environment; and
determining a smart home device corresponding to a respective second vector having the maximum correlation with the first vector as the smart home device associated with the environmental factor characterizing the smart home environment.

5. The method according to claim 2, wherein the generating the query associated with the smart home device comprises one of:
determining a current state of the smart home device associated with the environmental factor characterizing the smart home environment, and generating the query based on the current state of the environmental factor characterizing the smart home environment and a current state of the smart home device associated with the environmental factor characterizing the smart home environment, the query comprising a query whether to start the smart home device associated with the environmental factor characterizing the smart home environment;
determining the current state of the smart home device associated with the environmental factor characterizing the smart home environment, and generating the query based on the current state of the environmental factor characterizing the smart home environment and the current state of the smart home device associated with the environmental factor characterizing the smart home environment, the query comprising a query for control parameters of the smart home device associated with the environmental factor characterizing the smart home environment;
determining the current state of the smart home device associated with the environmental factor characterizing the smart home environment and a state of a user in the smart home environment, and generating the query based on the current state of the environmental factor characterizing the smart home environment, the current state of the smart home device associated with the environmental factor characterizing the smart home environment, r and the state of the user, the query comprising a query whether to start the smart home device associated with the environmental factor characterizing the smart home environment to meet requirements of the user; and
determining the current state of the smart home device associated with the environmental factor characterizing the smart home environment and the state of the user in the smart home environment, and generating the query based on the current state of the environmental factor characterizing the smart home environment, the current state of the smart home device associated with the environmental factor characterizing the smart home environment, and the state of the user, the query comprising a query for control parameters of the smart home device associated with the environmental factor characterizing the smart home environment to meet requirements of the user.

6. The method according to claim 2, further comprising:
converting description information of the smart home device associated with the environmental factor characterizing the smart home environment into a third vector;
determining correlations between the third vector and one or more fourth vectors, wherein each of the one or more fourth vectors is based on description information of a corresponding environmental factor in the smart home environment; and
based on a fourth vector among the one or more fourth vectors having a correlation higher than a predetermined threshold with the third vector, determining a respective environmental factor corresponding to the fourth vector as the environmental factor characterizing the smart home environment.

7. The method according to claim 6, wherein the generating the query associated with the smart home device comprises one of:
determining a current state of the smart home device associated with the environmental factor characterizing the smart home environment and a current state of the environmental factor associated with the environmental factor characterizing the smart home environment, and generating the query based on the current state of the environmental factor characterizing the smart home environment, the current state of the smart home device associated with the environmental factor characterizing the smart home environment, and the current state of the environmental factor associated with the environmental factor characterizing the smart home environment, the query comprising a query whether to start the smart home device associated with the environmental factor characterizing the smart home environment;
determining the current state of the smart home device associated with the environmental factor characterizing the smart home environment and a current state of the environmental factor associated with the environmental factor characterizing the smart home environment, and generating the query based on the current state of the environmental factor characterizing the smart home environment, the current state of the smart home device associated with the environmental factor characterizing the smart home environment, and the current state of the environmental factor associated with the environmental factor characterizing the smart home environment, the query comprising a query for control parameters of the smart home device associated with the environmental factor characterizing the smart home environment;
determining the current state of the smart home device associated with the environmental factor characterizing the smart home environment, the current state of the environmental factor associated with the environmental factor characterizing the smart home environment, and a state of a user in the smart home environment, and generating the query based on the current state of the environmental factor characterizing the smart home environment, the current state of the smart home device associated with the environmental factor characterizing the smart home environment, the current state of the environmental factor associated with the environmental factor characterizing the smart home environment, and the state of the user, the query comprising a query whether to start the smart home device associated with the environmental factor characterizing the smart home environment to meet requirements of the user; and
determining the current state of the smart home device associated with the environmental factor characterizing the smart home environment, the current state of the environmental factor associated with the environmental factor characterizing the smart home environment, and the state of the user in the smart home environment, and generating the query based on the current state of the environmental factor characterizing the smart home environment, the current state of the smart home device associated with the environmental factor characterizing the smart home environment, the current state of the environmental factor associated with the environmental factor characterizing the smart home environment, and the state of the user, the query comprising a query for control parameters of the smart home device associated with the environmental factor characterizing the smart home environment to meet requirements of the user.

8. The method according to claim 5, wherein the method further comprises:
receiving a feedback of the user on a control effect; and
adjusting the requirements of the user based on the feedback.

9. An apparatus for controlling a smart home device, the apparatus comprising:
memory storing instructions; and
one or more processors,
wherein the instructions, when executed by the one or more processors individually or collectively, cause the apparatus to:
determine a smart home device that is associated with an environmental factor to be controlled;
generate a query associated with the smart home device based on a current state of the environmental factor to be controlled;
input the query into a large language model;
obtain a reply generated based on the query text from the large language model;
convert the reply from the large language model into a control instruction for the smart home device; and
control the smart home device based on the control instruction.

10. The apparatus according to claim 9, wherein the instructions, when executed by the one or more processors individually or collectively, cause the apparatus to:
determine, based on a change to an environmental factor characterizing a smart home environment, the environmental factor characterizing the smart home environment as the environmental factor to be controlled; or
extract, based on a description of a control target, a keyword from the control target, and determine an environmental factor associated with the keyword as the environmental factor to be controlled; or
determine, based on a predetermined condition being satisfied, an environmental factor associated with the predetermined condition as the environmental factor to be controlled.

11. The apparatus according to claim 10, wherein the instructions, when executed by the one or more processors individually or collectively, cause the apparatus to:
determine description information of the environmental factor characterizing a smart home environment based on a name of the environmental factor characterizing a smart home environment and a current state of the environmental factor characterizing the smart home environment;
convert the description information into a first vector;
determine correlations between the first vector and one or more second vectors, wherein each of the one or more second vectors is based on description information of a corresponding smart home device in the smart home environment; and
determine a smart home device corresponding to a respective second vector having the maximum correlation with the first vector as the smart home device associated with the environmental factor characterizing the smart home environment.

12. The apparatus according to claim 10, wherein the instructions, when executed by the one or more processors individually or collectively, cause the apparatus to:
determine a current state of the smart home device associated with the environmental factor characterizing the smart home environment, and generate the query based on the current state of the environmental factor characterizing the smart home environment and a current state of the smart home device associated with the environmental factor characterizing the smart home environment, the query comprising a query whether to start the smart home device associated with the environmental factor characterizing the smart home environment;
determine the current state of the smart home device associated with the environmental factor characterizing the smart home environment, and generate the query based on the current state of the environmental factor characterizing the smart home environment and the current state of the smart home device associated with the environmental factor characterizing the smart home environment, the query comprising a query for control parameters of the smart home device associated with the environmental factor characterizing the smart home environment;
determine the current state of the smart home device associated with the environmental factor characterizing the smart home environment and a state of a user in the smart home environment, and generate the query based on the current state of the environmental factor characterizing the smart home environment, the current state of the smart home device associated with the environmental factor characterizing the smart home environment, r and the state of the user, the query comprising a query whether to start the smart home device associated with the environmental factor characterizing the smart home environment to meet requirements of the user; or
determine the current state of the smart home device associated with the environmental factor characterizing the smart home environment and the state of the user in the smart home environment, and generate the query based on the current state of the environmental factor characterizing the smart home environment, the current state of the smart home device associated with the environmental factor characterizing the smart home environment, and the state of the user, the query comprising a query for control parameters of the smart home device associated with the environmental factor characterizing the smart home environment to meet requirements of the user.

13. The apparatus according to claim 10, wherein the instructions, when executed by the one or more processors individually or collectively, cause the apparatus to:
convert description information of the smart home device associated with the environmental factor characterizing the smart home environment into a third vector;
determine correlations between the third vector and one or more fourth vectors, wherein each of the one or more fourth vectors is based on description information of a corresponding environmental factor in the smart home environment; and
based on a fourth vector among the one or more fourth vectors having a correlation higher than a predetermined threshold with the third vector, determine a respective environmental factor corresponding to the fourth vector as the environmental factor characterizing the smart home environment.

14. The apparatus according to claim 13, wherein the instructions, when executed by the one or more processors individually or collectively, cause the apparatus to:
determine a current state of the smart home device associated with the environmental factor characterizing the smart home environment and a current state of the environmental factor associated with the environmental factor characterizing the smart home environment, and generate the query based on the current state of the environmental factor characterizing the smart home environment, the current state of the smart home device associated with the environmental factor characterizing the smart home environment, and the current state of the environmental factor associated with the environmental factor characterizing the smart home environment, the query comprising a query whether to start the smart home device associated with the environmental factor characterizing the smart home environment; or
determine the current state of the smart home device associated with the environmental factor characterizing the smart home environment and a current state of the environmental factor associated with the environmental factor characterizing the smart home environment, and generate the query based on the current state of the environmental factor characterizing the smart home environment, the current state of the smart home device associated with the environmental factor characterizing the smart home environment, and the current state of the environmental factor associated with the environmental factor characterizing the smart home environment, the query comprising a query for control parameters of the smart home device associated with the environmental factor characterizing the smart home environment; or
determine the current state of the smart home device associated with the environmental factor characterizing the smart home environment, the current state of the environmental factor associated with the environmental factor characterizing the smart home environment, and a state of a user in the smart home environment, and generate the query based on the current state of the environmental factor characterizing the smart home environment, the current state of the smart home device associated with the environmental factor characterizing the smart home environment, the current state of the environmental factor associated with the environmental factor characterizing the smart home environment, and the state of the user, the query comprising a query whether to start the smart home device associated with the environmental factor characterizing the smart home environment to meet requirements of the user; or
determining the current state of the smart home device associated with the environmental factor characterizing the smart home environment, the current state of the environmental factor associated with the environmental factor characterizing the smart home environment, and the state of the user in the smart home environment, and generating the query based on the current state of the environmental factor characterizing the smart home environment, the current state of the smart home device associated with the environmental factor characterizing the smart home environment, the current state of the environmental factor associated with the environmental factor characterizing the smart home environment, and the state of the user, the query comprising a query for control parameters of the smart home device associated with the environmental factor characterizing the smart home environment to meet requirements of the user.

15. The apparatus according to claim 14, wherein the instructions, when executed by the one or more processors individually or collectively, cause the apparatus to:
receive a feedback of the user on a control effect; and
adjust the requirements of the user based on the feedback.

16. A non-transitory computer-readable medium storing one or more instructions that are executed by one or more processors, individually or collectively, to perform a method for controlling a smart home device, the method comprising:
determining a smart home device that is associated with an environmental factor to be controlled;
generating a query text associated with the smart home device based on a current state of the environmental factor to be controlled;
inputting the query text into a large language model;
receiving obtaining a reply text generated based on the query text from the large language model;
converting the reply text from the large language model into a control instruction of for the smart home device; and
controlling the smart home device based on the control instruction.

17. The non-transitory computer-readable medium according to claim 16, wherein the determining the smart home device that is associated with the environmental factor to be controlled comprises one of:
determining, based on an environmental factor characterizing a smart home environment being changed, the environmental factor characterizing the smart home environment as the environmental factor to be controlled;
extracting, based on a description of a control target, a keyword from the control target, and determining an environmental factor associated with the keyword as the environmental factor to be controlled; and
determining, based on a predetermined condition being satisfied, an environmental factor associated with the predetermined condition as the environmental factor to be controlled.

18. The non-transitory computer-readable medium according to claim 17, wherein the method further comprise:
determining that the environmental factor characterizing the smart home environment is changed,
wherein the determining that the environmental factor characterizing the smart home environment is changed comprises:
determining a value of the environmental factor characterizing the smart home environment based on an operation of a sensor disposed in the smart home environment or based on reading data from an environmental factor data source;
determining, based on the value of the environmental factor characterizing the smart home environment and a plurality of preset value intervals, a value interval corresponding to the value of the environmental factor characterizing the smart home environment;
determining a state of the environmental factor characterizing the smart home environment based on the value interval; and
determining that the environmental factor is changed based on the state of the environmental factor characterizing the smart home environment.

19. The non-transitory computer-readable medium according to claim 16, wherein the determining the smart home device that is associated with the changed environmental factor comprises:
determining description information of the environmental factor characterizing a smart home environment based on a name of the environmental factor characterizing a smart home environment and a current state of the environmental factor characterizing the smart home environment;
converting the description information into a first vector;
determining correlations between the first vector and one or more second vectors, wherein each of the one or more second vectors is based on description information of a corresponding smart home device in the smart home environment; and
determining a smart home device corresponding to a respective second vector having the maximum correlation with the first vector as the smart home device associated with the environmental factor characterizing the smart home environment.

20. The non-transitory computer-readable medium according to claim 16, wherein the generating the query associated with the smart home device comprises one of:
determining a current state of the smart home device associated with the environmental factor characterizing the smart home environment, and generating the query based on the current state of the environmental factor characterizing the smart home environment and a current state of the smart home device associated with the environmental factor characterizing the smart home environment, the query comprising a query whether to start the smart home device associated with the environmental factor characterizing the smart home environment;
determining the current state of the smart home device associated with the environmental factor characterizing the smart home environment, and generating the query based on the current state of the environmental factor characterizing the smart home environment and the current state of the smart home device associated with the environmental factor characterizing the smart home environment, the query comprising a query for control parameters of the smart home device associated with the environmental factor characterizing the smart home environment;
determining the current state of the smart home device associated with the environmental factor characterizing the smart home environment and a state of a user in the smart home environment, and generating the query based on the current state of the environmental factor characterizing the smart home environment, the current state of the smart home device associated with the environmental factor characterizing the smart home environment, r and the state of the user, the query comprising a query whether to start the smart home device associated with the environmental factor characterizing the smart home environment to meet requirements of the user; and
determining the current state of the smart home device associated with the environmental factor characterizing the smart home environment and the state of the user in the smart home environment, and generating the query based on the current state of the environmental factor characterizing the smart home environment, the current state of the smart home device associated with the environmental factor characterizing the smart home environment, and the state of the user, the query comprising a query for control parameters of the smart home device associated with the environmental factor characterizing the smart home environment to meet requirements of the user.
